(19) United States
(12) Patent Application Publication
(10) Pub. No.: US 2016/0239584 A1
(43) Pub. Date: Aug. 18, 2016

(54) TOTAL QUALITY MANAGEMENT SYSTEM AND METHOD FOR ANNOTATING AND VISUALIZING DEFECTS IN MANUFACTURED PARTS

(71) Applicant: Tribase Systems, Inc., Troy, MI (US)

(72) Inventor: Richard Steele, JR., Troy, MI (US)

(21) Appl. No.: 15/136,631

(22) Filed: Apr. 22, 2016

Related U.S. Application Data
(63) Continuation-in-part of application No. 14/217,355, filed on Mar. 17, 2014.
(60) Provisional application No. 62/151,571, filed on Apr. 23, 2015.
(60) Provisional application No. 61/802,905, filed on Mar. 18, 2013.

(51) Int. Cl. G06F 17/50; G06T 7/00

(52) U.S. Cl. CPC G06F 17/50; G06T 7/0002

(57) ABSTRACT

A system and method for annotating defects in a part to be inspected includes a plurality of defect annotations for the part where each of the defect annotations has a type and a severity, and a Computer Aided Design (CAD) model of the part stored on a nonvolatile memory where the CAD model includes of a plurality of geometrical features where each of the geometrical features is optionally associated with one or more of the plurality of defect annotations.

### CROSS-REFERENCE TO RELATED APPLICATIONS

This application claims priority to and all the benefits of U.S. Provisional Patent Application Ser. No. 62/151,571, filed Apr. 23, 2015, and is a continuation-in-part of U.S. Ser. No. 14/217,355, filed on Mar. 17, 2014, entitled “System and Method for Collecting and Analyzing Manufacturing Defects for Continuous Quality Control,” which claims the benefit of U.S. Provisional Patent Application Ser. No. 61/802,905, filed on Mar. 18, 2013, the disclosures of all of which are hereby incorporated by reference in their entirety.

### BACKGROUND OF THE INVENTION

1. Field of the Invention

The present invention relates generally to a system and method for annotating and visualizing defects in manufactured parts where the defects are annotated directly on the CAD model of the manufactured part and subsequently used for generating reports for quality control and acceptance.

2. Description of the Related Art

Solid models in the modern computer-aided design (CAD) environments describe the shape and form of manufactured artifacts and are gaining ubiquity for effectively managing and resulting in creation of digital libraries of large design and manufacturing enterprises that will ultimately be responsible for reducing manufacturing costs through lean manufacturing principles. Inspection and acceptance of the manufactured parts is a critical step in ensuring that the parts meet their requisite standards and in some cases—particularly for safety critical applications such as aeronautical, space, and naval applications—must satisfy the mandated governmental standards for safety.

In industrial environments, human inspectors typically perform inspection either on a small sized samples drawn from a batch, or if required in safety critical applications, on 100% of the manufactured parts. Automation of the visual inspection process is desirable to reduce errors in recording and managing the customer's acceptance of the part where the quality of the manufactured part must be established for each and every part manufactured. Automated systems that track and record the trends for defects observed in the manufactured parts ultimately help engineers perform the root cause analysis for frequent defects and thereby help improve the manufacturing processes.

A key component of the automated inspection system is the use of an imaging film that is used for archiving all the inspection images of a part used during the inspection and quality assurance process. Images of the various sections of the manufactures part are stored in an X-Ray based imaging system described in a patent application by the same inventor entitled, “System and Method for Collecting and Analyzing Manufacturing Defects for Continuous Quality Control,” application Ser. No. 14/217,355, which is incorporated herein by reference.

The root cause analysis for identifying the manufacturing processes that cause a specific defect often requires an analysis of the film to get further information about the types of defects and their potential causes. What is needed is the use of digital film that gives engineers an immediate access to the images rather than having to sort through film packets. The process of searching through the collection of digital images, sorting through all of the digital images, and locating the appropriate image can be easily facilitated through the appropriate indexing of images and linking images to the 3D CAD model including the annotations of how the part was shot and where all of the defects are as a whole to efficiently discover improvements in the manufacturing process to create defect free parts. The system disclosed is designed to show a full 3D CT-XRAY scan showing all of the defects in a digital image by overlaying these on the CAD model that can be visualized by spinning the part around and viewing the different angles to examine and inspect the whole part.

What is also needed is a system that enables the estimation of severity of a defect in reference to the exact sizes of the standard acceptable limits for rating the defect severity. The system disclosed includes a standardized method for rating the severity of defects by comparing them to the pre-stored samples depicting and quantitating defect severity.

Further, what is needed is a standardized system for utilizing a 3DPDF that once the correlating part enters the inspection process all relevant quality information associated with the part, such as inspection results from multiple methods of inspection, gets entered onto the 3DPDF and has a “certified” inspector digital signature from each inspection method performed.

If digital film is incorporated and effectively replaces film for certain projects/parts, the system disclosed allows those images to be stored and accessed directly by the system's interface. All digital images and process information are stored in a centralized database. While the disclosed system works well when digital film is utilized, the system works equally well with any type of imaging techniques provided the images are later digitized and integrated into a centralized database.

Further, what is needed is a general purpose inspection system for including the defect information on a Computer Aided Design (CAD) model. Integrating information included into a CAD model lends itself to achieving a total quality management with the visual display of the surfaces and the density and severity of defects included thereupon where a geometrical surface analysis from the model can be correlated to the likelihood of defect formation. The CAD model lends itself for allowing the part inspection process to “pin-point” the location of a defect thus making the entire process much more accurate when compared to identifying defects on a pre-defined region of a manufactured part. In this manner, the disclosed system overcomes a limitation inherent in currently utilized inspection systems that record defects in a region of lesser specificity when compared to the pin-point accuracy of recording and analyzing defects by the system disclosed herein.

Further, what is needed is a system for visualization of the defect density across an ensemble of inspected parts. As defects get annotated on the CAD model and saved to a database, an average defect profile is constructed by a functional analysis of defects across the entire population of parts inspected. With such a visualization, engineers gain valuable insight to performing failure analysis in conjunction with the propensities of defect occurrences. Since a CAD model relies on the use of surfaces, a defect density function can be associated with the probability of finding a defect at a given location on the constituent surface. The mathematical probabilities of defects define the defect density and are then visualized using a heat-map that provides design engineers with key information about the regions of the part that needs to be redesigned to reduce their defect propensities. This empirical knowledge acquired by the use of the system disclosed offers the advantages of achieving total quality management by improving all the processes including the design of the part.

Further, what is needed is a system that is backward compatible with the traditional quality assurance processes followed by the industry. The integration of defects into the CAD model can continue to generate inspection reports needed for “buy-offs” of the part by customers. Further, an inspection report listing severity and type of defects can also serve as an input to the visualization engine disclosed. Since part inspection relies on tessellation of the surface into regions where the testing for defects is focused, the availability of defects for each region can be an input to the disclosed system. The system maps these regions back to the tessellated surfaces in the CAD geometry and provides a visualization of defects detected on the part. In this manner, a report of defects is integrated by the system and allows for defect information to be fed back to the part designers where proactive design decisions can be made to refine the part design and make it less prone to defects.

### SUMMARY OF THE INVENTION

The present invention provides a system and method for automating the inspection process of manufactured parts. In one embodiment, the present invention provides a system for annotating defects in a part to be inspected including a plurality of defect annotations for the part where each of the defect annotations has a type and a severity, and a Computer Aided Design (CAD) model of the part stored on a nonvolatile memory where the CAD model includes of a plurality of geometrical features where each of the geometrical features is optionally associated with one or more of the plurality of defect annotations.

In one embodiment, the present invention provides a method of learning for a system for annotating defects in a part including the steps of analyzing engineering data, inspection defect data, repair data (times associated with particular defect types and specific part locations of the defect) for the part, and displaying “optimum” engineering parameters for manufacturing the part.

The system utilizes a CAD database capturing a 3D representation of manufactured part. Subsequent to the manufacturing of the part, the part is presented to a human inspector or a machine vision based inspection system. The inspector views the image of the part and retrieves the corresponding CAD view whereupon the imaged section of the part is outlined. The inspector examines the part image and determines if there is any defects observable on the part. Correspondingly, if a certain defect type is observed on the image, the inspector annotates the CAD model view at the appropriate position and with the type and severity of the observed defect with “pin-point” accuracy.

The inspector continues film by film and view by view. The system automatically rotates the 3D part drawing to the desired orientation corresponding to the view being inspected and then zooms in to limit the field of view to what is seen on the film. Once all views have been inspected, all noted indications are entered in on the system drawing in accordance to the XRAY or image of the corresponding view. All indications are then completely laid out visually on the 3D system drawing which can then be rotated around.

Since all indications are based on specific shapes and sizes in accordance to the standard reference plates, the system renders what each defect would theoretically look like based on the plate and render that image into the 3D system drawing. With a complete 3-dimensional (3D) animated view complete with annotations labeling plate sizes essentially renders a “true-view” of the part for enabling visualization of what a full digital 3D CT-scan of the full part with included defects will look like.

There are multiple methods for non-destructive testing of parts. The system disclosed is designed to work with all types of part inspection methods since today's manufacturing relies on parts designed with 3D engineering software and all critical parts must be inspected with some form of inspection process to be deemed acceptable for use.

As will be appreciated by a skilled artisan, automated visual inspection system uses imaging for detection of defects in casting or other manufactured parts. Such a system uses computer-aided design (CAD) model information in several stages, including surface classification and inspection. Inspection techniques often utilize comparison of the CAD model to the image of the part for the detection common defects and for the inspection of dimensional tolerances and manufacturing features. The technique described in this application is applicable for inspection systems where human inspectors perform the inspection as well as where the inspection is performed by computer algorithms that analyze surfaces or X-Ray images for internal inspection or range images. The methods described in this application are applicable to a number of images of castings, machined or assembled parts that need to be inspected for defects.

In another embodiment, the XRAY-radiography inspection method process would be: the XRAY technician utilizes a 3DPDF with the part itself to design and setup the XRAY technique process of inspection. As the technician sets up each individual view, they rotate the 3DPDF to the same corresponding specific part setup as shown with the real part. They continue through the remaining XRAY views and continue rotating the 3DPDF accordingly to match each corresponding XRAY part setup as would be recorded on the XRAY film. All associated machine settings and technical setup data would be tracked and logged onto the 3DPDF for each view setup. The conclusion of this process would have a complete 3DPDF document with all XRAY views sorted to where with a drop-down selection box could pick a selected view and perform the inspection process. This 3DPDF would then be used to record all XRAY inspection results based on the finding the technicians discovers on the XRAY film (be it digital film or regular film). The inspector annotates onto the 3DPDF accordingly based on the same annotations on the XRAY film. When the XRAY inspection process is completed, the full-rotating capable 3DPDF would then display all defects as if it were a full CT-XRAY scan. The XRAY inspector then digitally signs and “stamps” the 3DPDF as if it were a paper document. The results of the 3DPDF annotations would then also provide the capabilities to print out a “standardized” inspection report that would summarize all indications discovered by the inspector. This document would also be physically signed and stamped by the inspector and would act as the physical copy inspection record to be used in reference with the 3DPDF digital document. The part and 3DPDF would then travel to the remaining inspection methods and be utilized in the same manner as the XRAY inspection process. Once the part has completed throughout the entire inspection process, what would remain is a fully annotated digital 3DPDF easily displaying the inspection results from every process digitally signed by every inspector that has performed the “certified” inspection process for that part. If there were accompanying digital XRAY films, these images could be “hyper-linked” to the 3DPDF and digital database for the associated part. The engineer/customer can then easily see exactly what the defect looked like on the film but also quickly discover where all of the defects were found on the entire part by being able to rotate the 3DPDF.

One advantage of the present invention is that a system and method is disclosed for recording critical information related to the quality of a manufactured part directly into a 3DPDF. Another advantage of the present invention is that the 3DPDF document would travel with the part throughout its entire life cycle.

Other features and advantages of the present invention will be readily appreciated, as the same becomes better understood, after reading the subsequent description taken in conjunction with the accompanying drawings.

### BRIEF DESCRIPTION OF THE DRAWINGS

FIG. 1 is a view of a block diagram of an apparatus depicting an embodiment of the present invention where the image, X-Ray or under normal lighting, is communicated to a computer system where it is subsequently inspected for defects.

FIG. 2 is a view of an activity diagram depicting a sequence of activities needed for mapping the CAD model for the part to be inspected to imaging parameters for a series of images captured to inspect a manufactured part.

FIG. 3 is a view illustrating a data-flow diagram for generating image data and use of data inspector software for annotating defects on to the CAD models.

FIGS. 4A through 4E are views illustrating of the manufactured part corresponding to the various imaged sections where each of these views is mapped to a corresponding section of the CAD model shown.

FIG. 5 is a view illustrating a plurality of sections of a CAD part where the sections are created with the objective of totally covering the entire manufactured part.

FIG. 6 is a view illustrating a Graphical User Interface for a software used for annotating defects on the CAD model using the defects observed on the image sections of a manufactured part.

FIGS. 7A through 7D are views illustrating use of the software system for annotating defects on the CAD model using images obtained from a plurality of sections where a type and severity of defects observed on the image are annotated on the corresponding view of the CAD model.

FIG. 8A is a view illustrating standardized measurements of the types of defects where the size of the defect denotes severity such as defects caused by gas holes.

FIG. 8B is a view illustrating standardized measurements of the types of defects where the density of defects denotes the severity of the defects such as those caused by sand inclusions

FIG. 9 is a view of a component diagram of an architecture of a system.

FIGS. 10A and 10B are views depicting the generation of a report produced by the system where the annotation on the 3D models are transferred to a part acceptance report based on the zones where the defects were observed.

FIG. 11 is a perspective view illustrating the three-dimension visualization capability of the software where the defect annotated CAD models are viewed from multiple viewpoints.

FIG. 12 is a view of a flowchart of a method, according to the present invention, in devising a strategy for assuring and generating a complete test plan for coverage of the entire part.

FIGS. 13A and 13B are views illustrating a process of aligning the CAD model to the camera coordinates to register the CAD model with the imaging specific sections of the manufactured part, wherein a transformation matrix derived from the camera coordinates, and pan and tilt angles is used to transform the CAD part.

FIG. 14 is a view illustrating a roundtrip annotation and report generation capability provided by a software system.

### DESCRIPTION OF THE PREFERRED EMBODIMENT(S)

Computer Aided Design (CAD) is used for designing and manufacturing parts. The part inspection systems are lagging since they are typically based on using a tradition inspection based approach on imaging a manufactured part under a set of controlled lighting or imaging environments depending upon the specific needs of an application. The system disclosed in this application bridges a disconnect between the design and inspection of the manufactured part by including the results of the inspection directly into the CAD database. By feeding the defect density information back into the design process, the disclosed system achieves the benefits of total quality management where the part is designed to be correct by construction.

The present invention disclosed in this application relates to the improvement of current part inspection processes. A system, according to one embodiment of the present invention, disclosed enables the capturing of manufacturing defects directly on to the CAD model of a manufactured part. As discussed above, such an approach offers numerous advantages and helps create a total quality management system with tight integration of defect occurrences with the design process and ultimately helps in designing parts that are correct by construction, i.e. significantly less prone to defects.

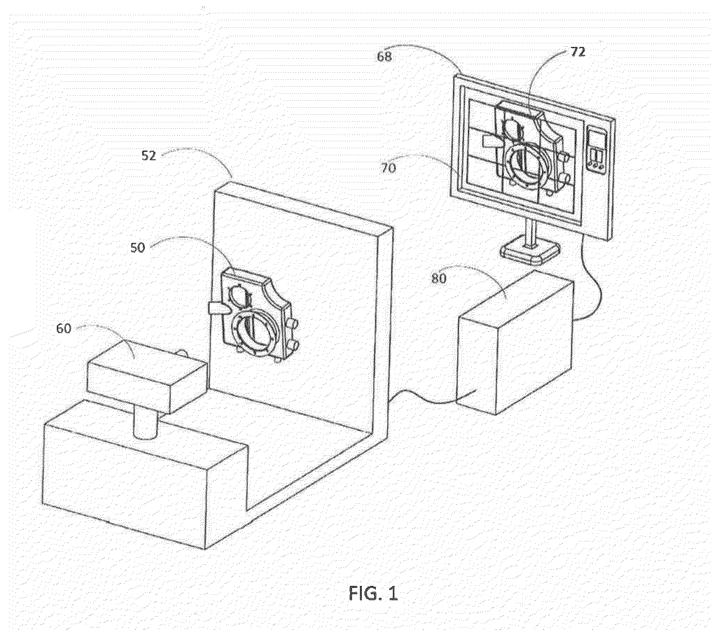

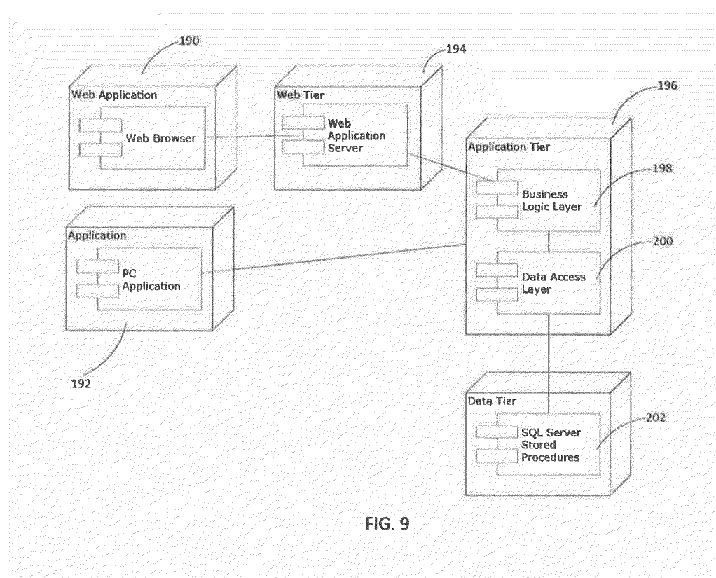

Referring to FIG. 1, one embodiment of an apparatus, according to one embodiment of the present invention, is shown where the image, X-Ray or under normal lighting, is communicated to a computer system where it is subsequently inspected for defects. FIG. 1 depicts a manufactured part 50 to be inspected mounted on an imaging platform or fixture 52 for imaging of the part 50 by an imaging device 60. The image is communicated to a database server 80 wherein the inspection image 120 is stored in an image database connected to the database server 80 through a database tier 202 (FIG. 9). Depending upon the complexity of the part 50, a plurality of images is stored in the database, the number of images generally being higher for a complex shaped part. The plurality of images are accessed by a computer or computing device 68 wherein the computing device 68 has the capability of displaying a corresponding computer aided design (CAD) model 72 on a display device 70.

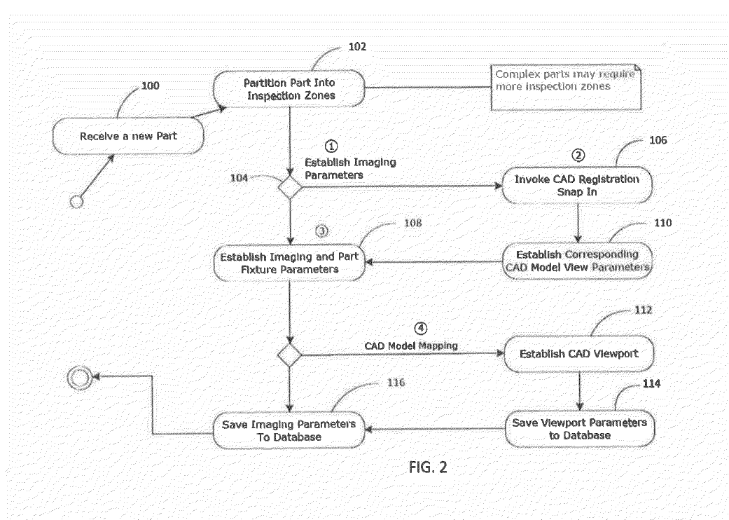

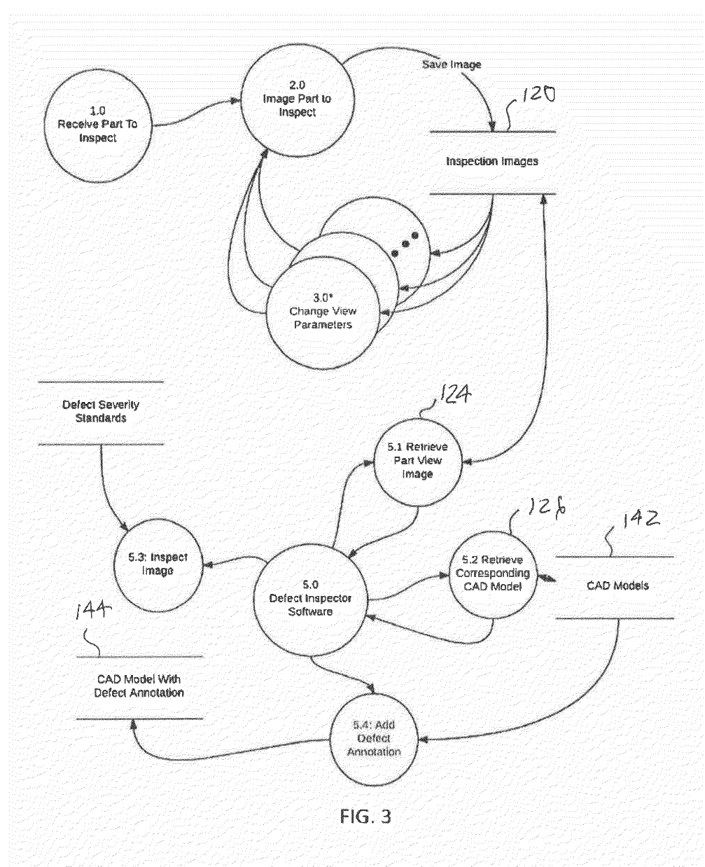

Referring to FIG. 2, an activity diagram is shown depicting the sequence of activities needed for mapping the CAD model 72 for the part 50 to be inspected to the imaging parameters for a series of images 120 (FIG. 3) captured to inspect the part 50. FIG. 2 depicts the sequence of activities performed for automating the inspection of the part 50 wherein the part 50 is received at 100 and partitioned at 102 to a plurality of inspection zones. The number the plurality of inspection zones is directly related to the complexity of the part 50 where the number of the plurality of zones is generally equal to the number of distinct imaging parameters and imaging positions that the part 50 is later imaged with during its inspection process. When necessary, the a number of imaging parameters are established at 104 corresponding to each of the plurality of inspection images 120 required for the part 50.

Upon establishing the imaging parameters at 104, the corresponding CAD viewing parameters are computed with the snap-in registration at 106 of the part 50 to its CAD model 72. This registration process is determining the “correspondence” between the CAD model 72 and each of the plurality of inspection images 120. This enables the inspector to later invoke the corresponding CAD viewport using CAD viewing parameters computed at 110. After determining the zones 102, and the corresponding CAD viewing parameters at 110, a plurality of fixture parameters at 108 to be used for holding the part 50 in the appropriate conformation for imaging by the imaging device 60. The correspondence between the CAD model 72 and imaging parameters having been established, a viewport at 112 on the CAD model 72 corresponding to the focus of the imaging device 60 representing the “target” of the inspection established. The viewport parameters and CAD viewing parameters are saved at 114 to a database. The imaging parameters and fixture holding position are also saved at 116 to the database.

Referring to FIG. 3, a data-flow diagram is shown for generating image data and the use of data inspector software for annotating defects on to the CAD models 72. FIG. 3 illustrates the flow of data in the defect visualization system. Based on the plurality of images needed the part imaged at 110 and the inspection images are saved at 120. The imaging device 60 images the part 50 using various parameters 122 with each of these images saved as inspection images at 122 to the database. In one embodiment of the present invention, all the imaging of the part 50 from various viewing parameters is completed before each of the plurality of inspection images at 120 is examined for presence of defects. In one embodiment of the present invention, adapted for use with digital imaging where the results of the imaging are available instantaneously, the processing step of taking each of the series of images is subsequently followed by an inspection of that image for occurrence of defects, and an annotation of the CAD model 72 with that defect. In one embodiment of the present invention, the imaging of a subset of all images is followed by the inspection of the subset of images. The subset of images selected for early inspection is determined by examining the relative frequency of defects in certain surface or volume regions that are prone to defects as evidenced by the past frequency of defects or difficulty in controlling processing parameters, or some other factor needing to be controlled for reducing defects.

During the inspection process which ensues, the software communicates with the database and performs a retrieval at 124 of a specific image of the part 50 from the inspection image 120. A retrieval at 126 of the CAD model 72 corresponding to the part imaging parameters is retrieved from a CAD model store at 142. Based on the defective regions detected by a human or machine based inspection at 132 of the image, comparison with the standard defect classification scheme at 140 occurs. The type and severity of defects is established if any defects are found in the part 50 being inspected. These systems perform an annotation 128 of defects found on the CAD models at 142 and saved the defect annotated CAD models 142 into the Defect Annotated CAD Models Store at 144. Each model stored with the defect annotation is related to the part 50 with a unique identifier associated with the part 50 which is also used for indexing and storing data in the Inspection Image Store at 120 and the Defect Annotated CAD Model Store at 144.

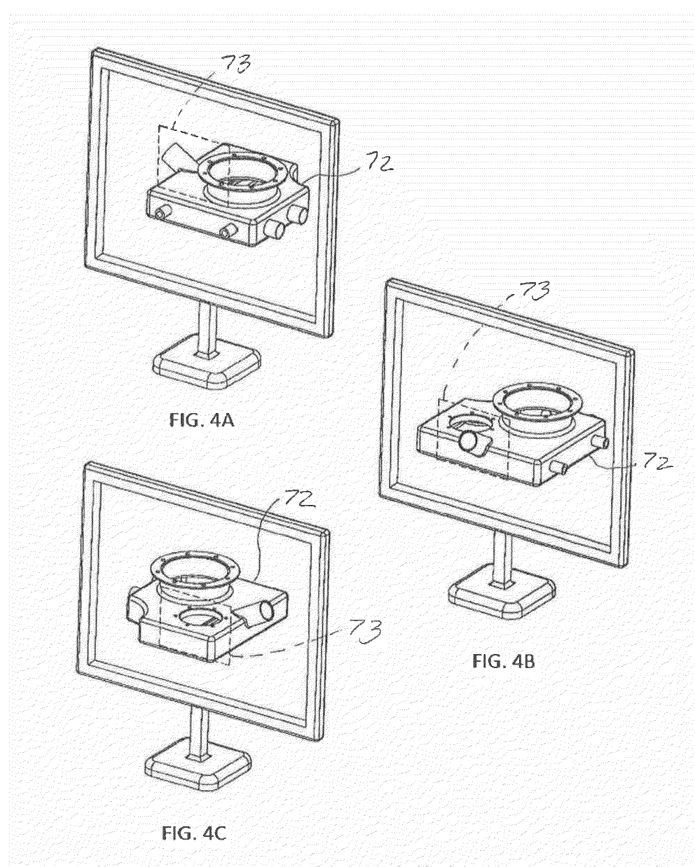

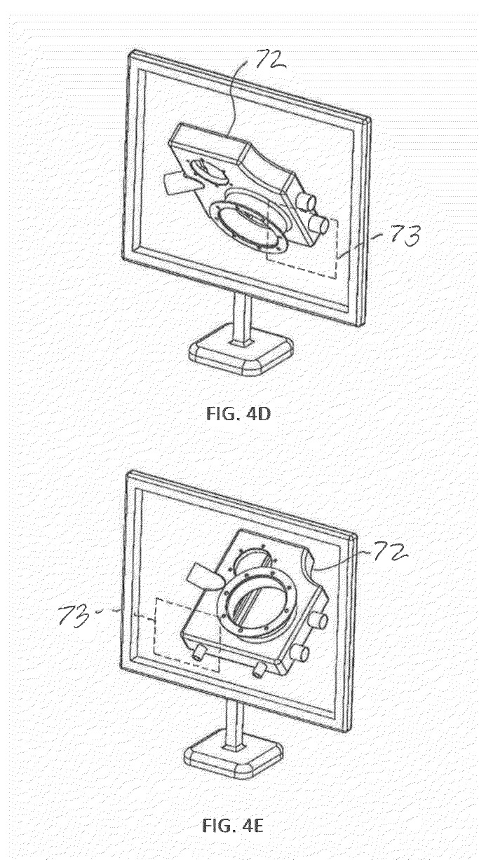

FIGS. 4A through 4E illustrate various views of the part 50 corresponding to the various imaged sections where each of these views is mapped to a corresponding section of the CAD model 72 shown. In one embodiment of the present invention, the imaging apparatus uses five distinct positions for imaging the part 50. In each of the different views of the CAD model 72 shown, region 73 where the imaging device 60 is focused is also shown. In this manner, the system facilitates the defect annotation process by circumscribing for the inspector the precise region of the CAD model 72 where the defects will need to be annotated. The system provides the ability for the user to go back and forth between the various CAD views and analyze the corresponding inspection images to annotate the defects in a focused and precise manner.

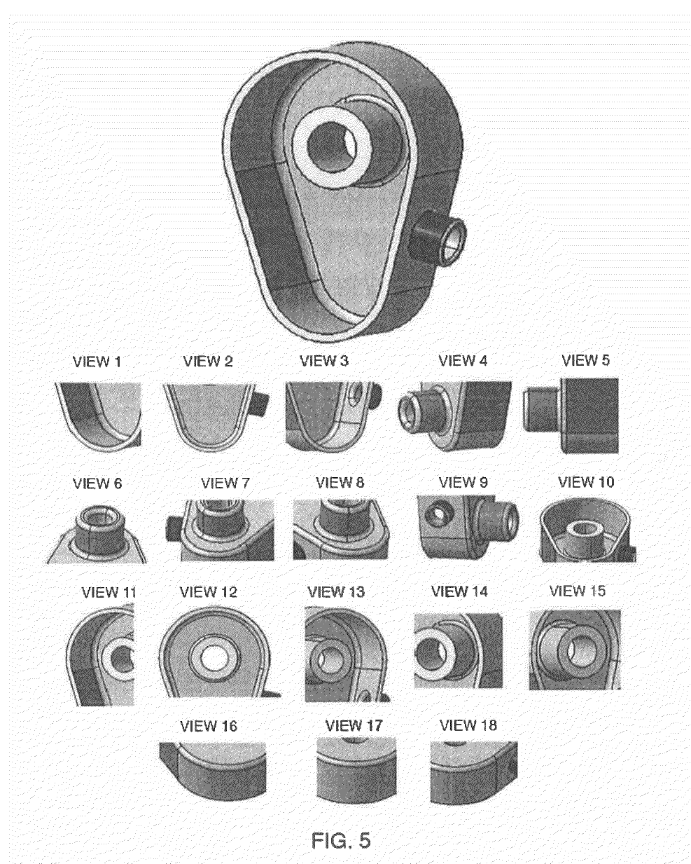

FIG. 5 illustrates a plurality of sections of a CAD part where the sections are created with the objective of totally covering the entire manufactured part 50. In the parlance of part inspection, the process of segmenting the full part into a plurality of images is called a “Technique.” In this step, the design engineer will fully analyze the part geometry and come up with a sectioning of the part 50 so as to completely cover the surfaces and interior cavities where manufacturing defects could occur. An image corresponding to each of these views will be inspected to determine if a defect is observable in that specific region of the part 50. As illustrated in FIG. 5, there are eighteen (18) views of the part that completely cover the part 50 from the standpoint of the locations where the defects could occur.

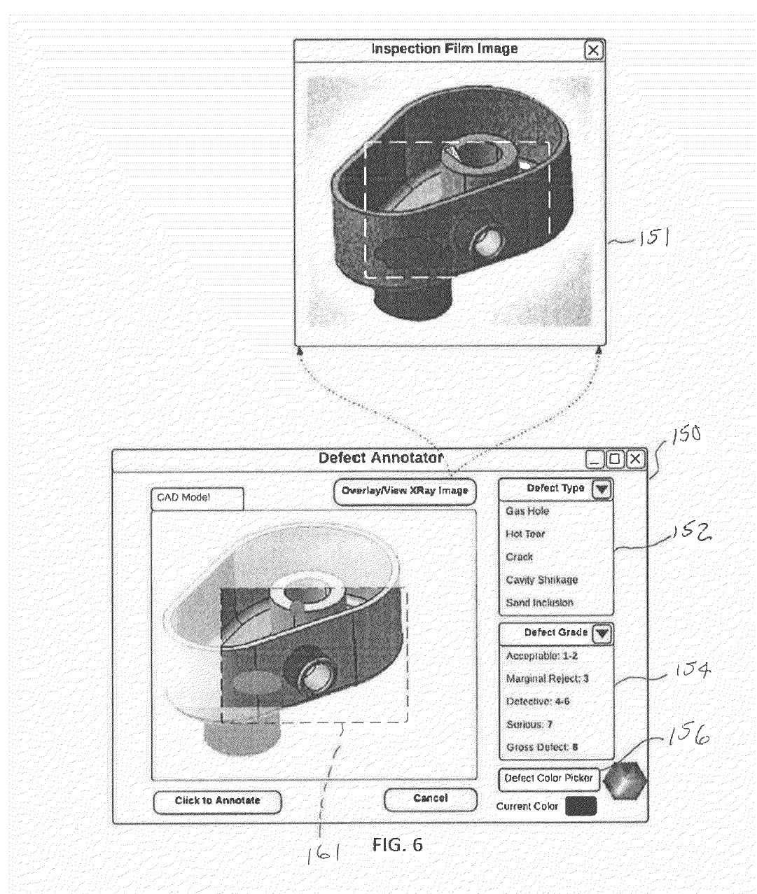

FIG. 6 is an illustration of the Graphical User Interface design for a software used for annotating defects on the CAD model 72 using the defects observed on the image sections of the part 50. The defect annotation software system 150 retrieves the CAD model 72 related to the zone being inspected. Using the previously saved CAD model viewing parameters 110, an appropriate view is created, and with the previously saved viewport parameters 112, a section of CAD model 72 is brought to the foreground 151. In one embodiment of the present invention, the section of the CAD model 72 belonging to the background is grayed out as illustrated. The outline of the foreground 151 of the CAD model 72 corresponds to the focus of the imaging device 60 onto the part 50 and represents the specific region of the part 50 that is subjected to inspection in that view.

The defect annotation software system 150 provides user interface elements for annotation of defects observed on the part 50. In one embodiment of the present invention, a defect selection tool 152 provides the ability for the user to specify the type of defect observed in the viewport region. The types of defects are specific to the type of manufacturing or molding process used. In one embodiment of the present invention when the system is utilized for annotating defects in parts molded in a foundry, the defect selection tool enables the user to select from common defect types including sand inclusions and gas holes. Associated with each defect type is also a severity of defect. The defect grade selection tool 154 allows the user to select the severity of a defect that needs to be annotated on the CAD model 72. Quantitative and qualitative measures of defect severity are supported by the defect annotation software system 150. In one embodiment of the present invention, the defect severity levels range from 1 through 8, where a defect severity of less than 3 is considered acceptable. The higher level defect severity annotations will generally point to the processing and manufacturing steps that need to be controlled in order to achieve a higher degree of quality control. The defect annotation software system 150 also provides the capability to annotate different defect types and defect severity with different colors. In one embodiment of the present invention, a defect annotation color selection tool 156 enables the user to pick a specific color for annotating defects on the CAD models.

The defect annotation software system 150 includes the functionality to overlay/display the image 158 over the CAD model 72 being annotated. When this functionality is invoked, the system displays the image 160 that corresponds to the viewport of the CAD model 72 displayed. In one embodiment of the present invention, the foreground 151 of the CAD model 72 is also highlighted as the image focus 161. This enables a real time examination of the image and enables an accurate annotation of the defects on the CAD model 72. The agent performing the defect annotation can zoom into the images 160 and visualize the location and other characteristics of the defect and make an accurate annotation on the CAD model 72.

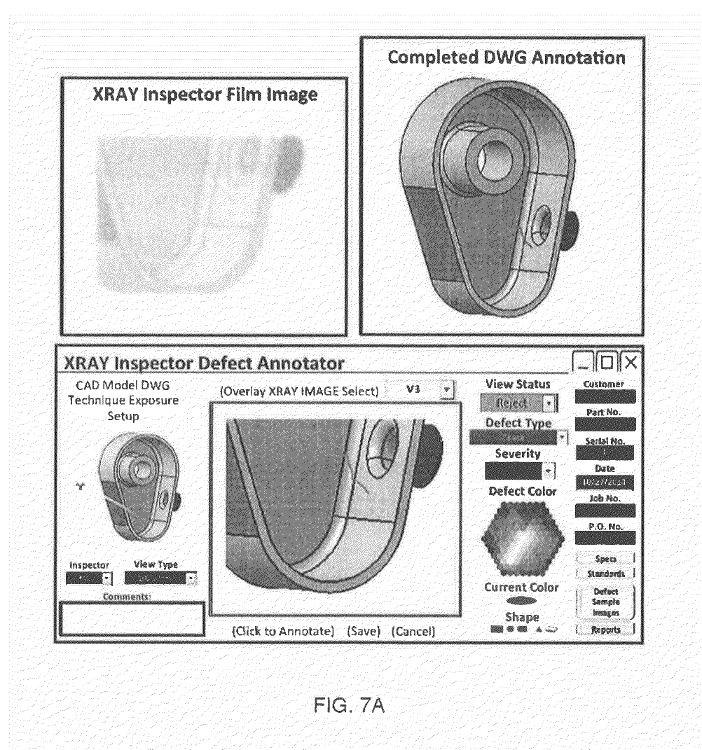

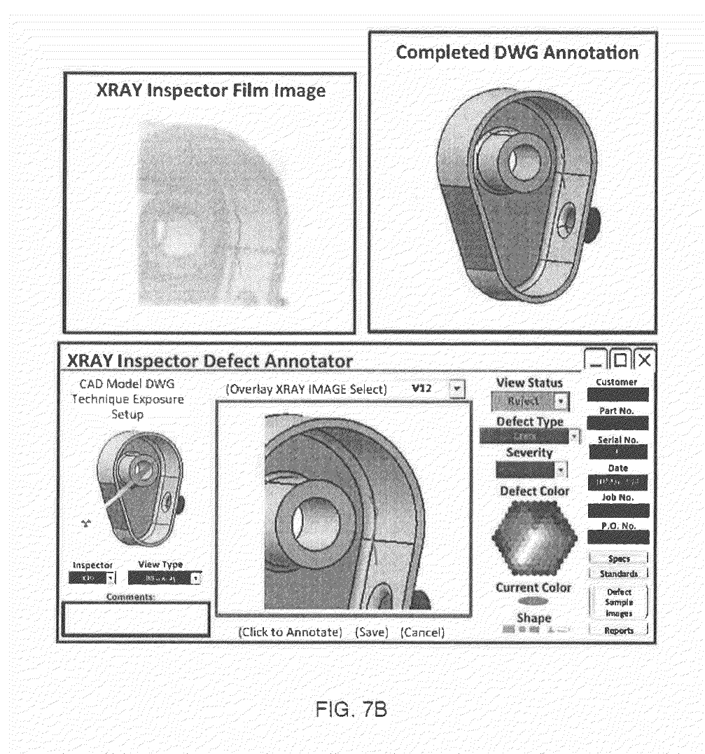

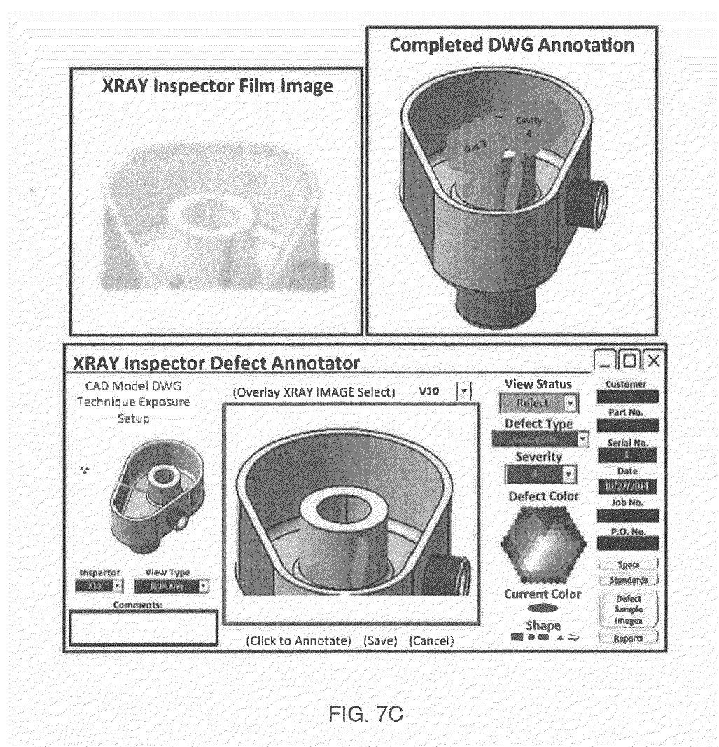

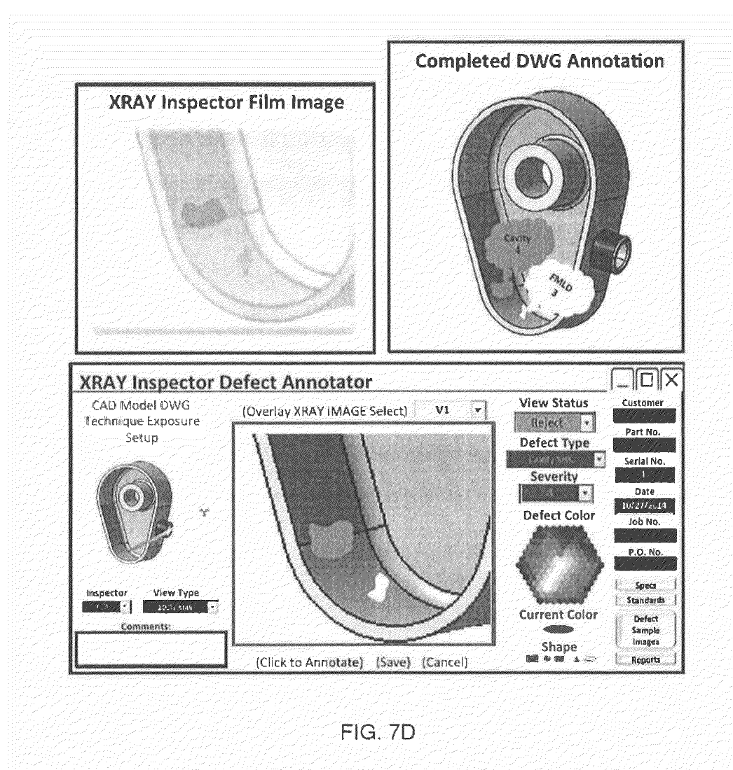

FIGS. 7A through 7D illustrate the use of the software system for annotating defects on the CAD model 72 using images obtained from a plurality of sections where a type and severity of defects observed on the images are annotated on the corresponding view of the CAD model 72.

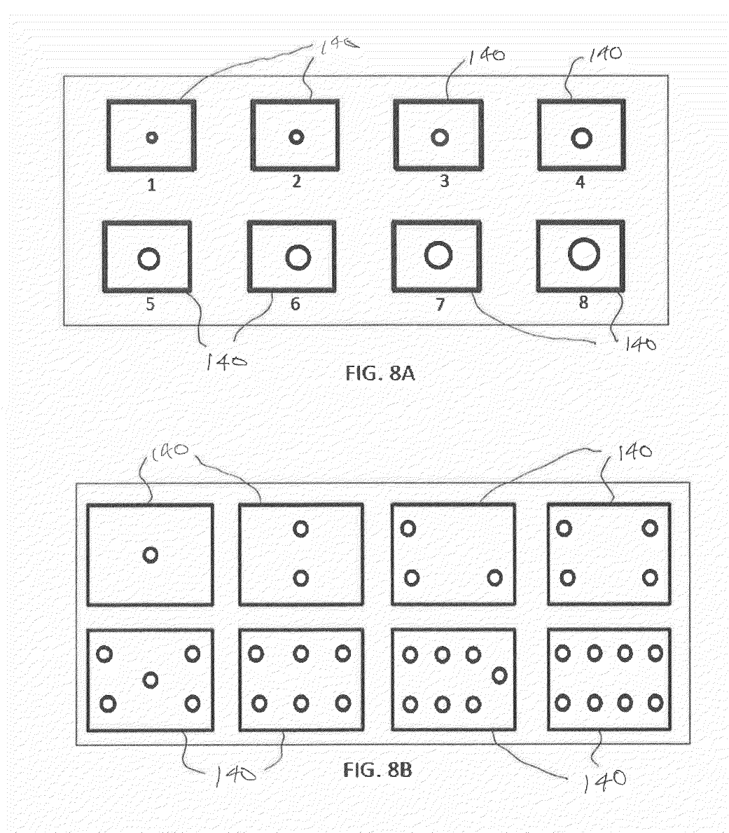

FIG. 8A illustrates the standardized measurements of the types of defects where the size of the defect denotes severity such as defects caused by gas holes. In one embodiment of the present invention, a plurality of images 140 documents the different grades of defects. In the illustration shown, the size of the defect is shown to govern the severity of defect.

FIG. 8B illustrates the standardized measurement of the types of defects where the density of defects denotes the severity of the defects such as those caused by sand inclusions. In one embodiment of the present invention, a plurality of images 140 documents the different grades of defects. In the illustration shown, the number of the similarly sized defects per unit area is shown to govern the severity of defect. For this type of point defect, the number of imperfections in a predefined unit of the region governs the severity of defect.

FIG. 9 is the component diagram of the architecture of a system. As shown in the illustration, various software components communicate with each other to support the various facets of the application. In one embodiment of the present invention, a Tablet or Web Application 190 is used by the part inspection agent to retrieve the image to be inspected and the CAD model 72 to be annotated. A functionality of the thin client such as a Tablet or a Web App 190 is supported by a Web Tier Application Server 194 supporting a Representational State Transfer (REST) based APL REST or Representational State Transfer, which is a simple stateless architecture for distributed hypermedia systems, ignoring details of component and protocol implementation, and only mandates using the basic “architectural style” of HTTP or the Hypertext Transfer Protocol. REST information flow is inherently redundant, as “all information necessary for a connector to understand the request” is contained within each invocation, rendering REST interaction stateless. The component 192 keeps all session state for the client 190. With the REST design, Web services can be seen as simply a means of publishing information, components and processes to make them accessible to other users and machine processes. In general, REST requires less client-side software than do other approaches, because a single, standard browser can access any application and data resource.

In one embodiment of the present invention, a PC based desktop application 192 is used for interacting with the server 194. The desktop application 192 includes a client component of the software application required to display the inspection images and required view of the CAD model 72. The desktop application 192 presents a view similar to the illustration of FIG. 6 in one embodiment of the present invention.

The desktop application 192 and the application server 194 supporting the web or tablet application 190 are supported by the application tier 196 in one embodiment of the present invention. In one embodiment of the present invention, a data tier 202 contains data for the CAD models 72 of the parts 50, the stored procedures necessary to integrate defects into the CAD models, as well as the images of the part 50 to be inspected. Corresponding to the part 50 being inspected, the data access engine 200 retrieves the appropriate information from the data tier 202. The information retrieved by the data access engine 200 is served to the CAD model 72 and part mapper 198. The function of the CAD model to part mapper is to compute the geometrical transformation between the imaged part and the CAD model 72. Thus, the CAD model to image mapper solved the “correspondence problem.” In one embodiment of the present invention, the correspondence problem is solved by a further refinement of the Iterative Closest Point process or algorithm where an improvement of data correspondence is determined by considering the merging data sets as a whole and determining an optimal correspondence while considering the plurality of part images.

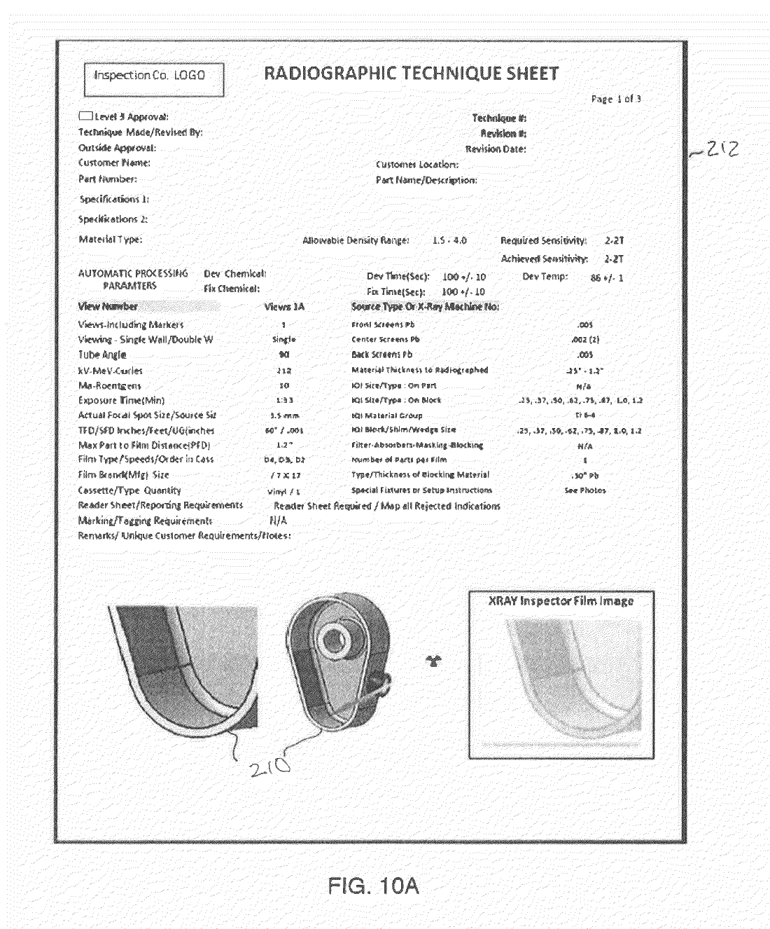

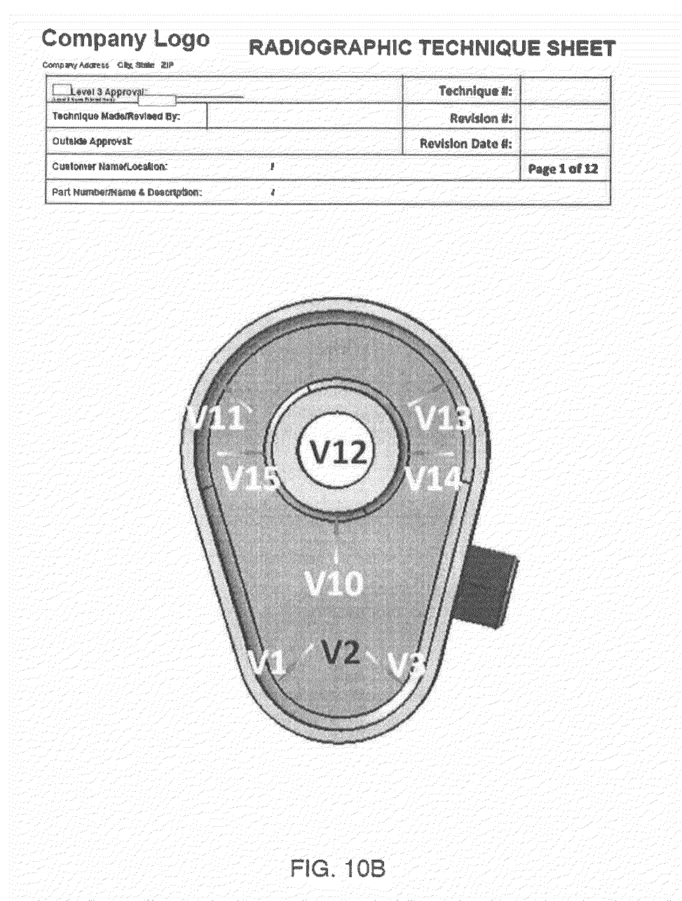

Referring to FIGS. 10A and 10B, a generation of a report produced by the system is shown where the annotation on the 3D models is transferred to a part acceptance report based on the zones where the defects were observed. Illustrated in FIGS. 10A and 10B are an inspection report 212 needed in one embodiment of the present invention wherein the inspection report 212 is needed to document that the part 50 was fully inspected and the result of such an inspection for each of the predetermined zones was recorded. The software system disclosed in this application enables the generation of this report directly from the CAD model information stored. For each of the CAD views 210 shown, the defects recorded during the inspection process are transferred to a report where the report correspondingly lists the type and severity of defects found in each of the CAD views 210, which in turn corresponds to each of the images of the part 50 to be inspected. The inspection report 212 then accompanies the part that is dispatched from the inspection or manufacturing facility and serves as an evidence of requisite Quality Control (QC) procedures having been applied to the manufactured or machined part 50.

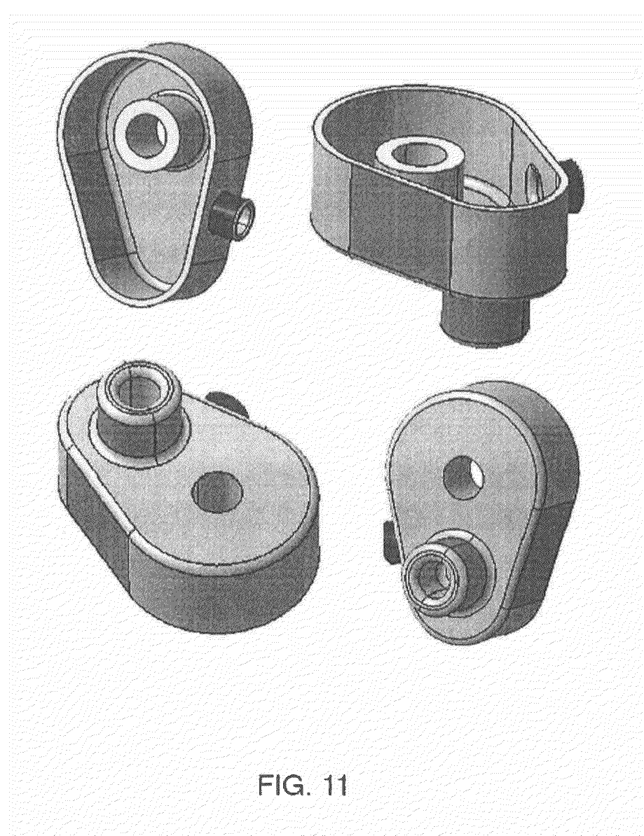

FIG. 11 illustrates the three-dimension visualization capability of the software where the defect annotated CAD models are viewed from multiple viewpoints. Any defects annotated by the inspectors are shown on these parts being visualized. The CAD interface further allows zooming into the region of the defect to determine if there are any surface related properties where the defects have a propensity of reoccurring.

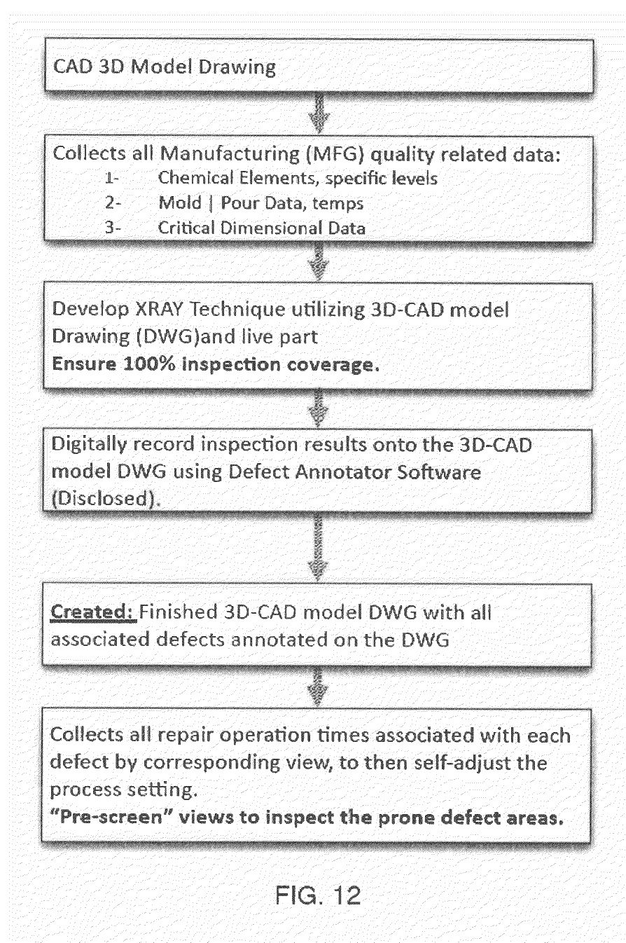

FIG. 12 is the flowchart of the steps in devising a strategy for assuring and generating a complete test plan for coverage of the entire part. As a first step it is important to record all the pertinent manufacturing parameters that will have bearing the occurrence of defects. Next, an appropriate technique must be designed that covers all the surfaces and cavities of the manufactured part 50. Next appropriate inspection images are recorded and examined by the inspector for each of segments or regions developed in the technique. The defects found in images are recorded upon the CAD models.

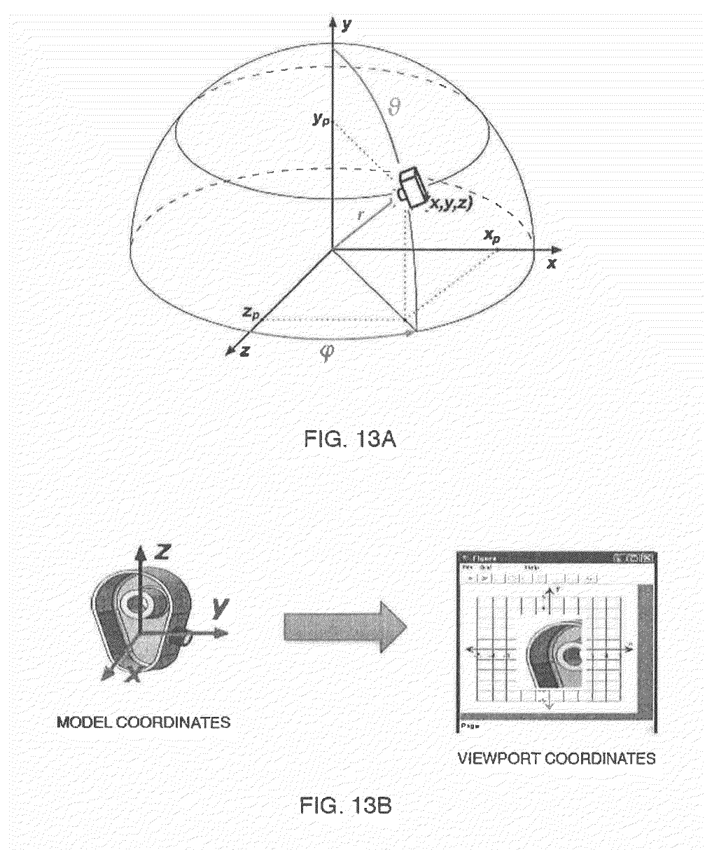

FIGS. 13A and 13B illustrate the process of aligning the CAD model 72 to the camera coordinates to register the CAD model 72 with the imaging specific sections of the manufactured part 50. The transformation matrix derived from the camera coordinates, and pan and tilt angles is used to transform the CAD part. This is essential for registering the CAD coordinate system with the image coordinate system. In one embodiment of the present invention, the parts being inspected are mounted upon a platform. The camera position, pan and zoom angles for each of the view can be used to calculate the object to image transformation matrix. The same transformations are applied to the 3D model to bring the images and CAD model views in alignment. The aligned views are next used for annotation of defects upon the CAD model 72. The annotated models are saved to the database along with the manufacturing parameters and part identification information.

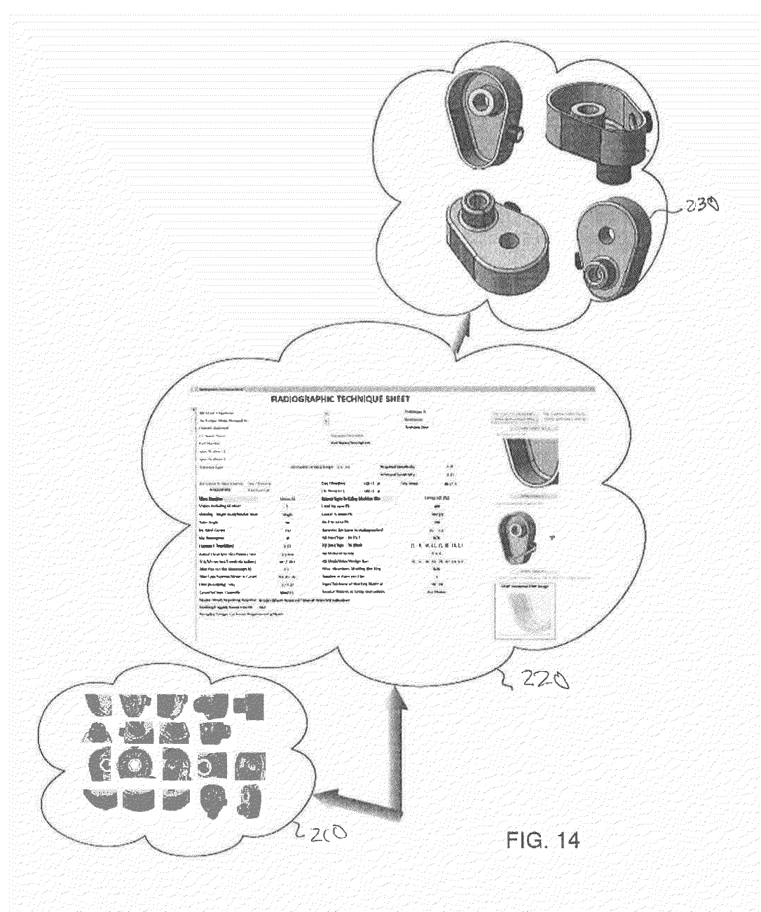

FIG. 14 illustrates the roundtrip annotation and report generation capability provided by the software system disclosed. As illustrated, the disclosed system allows for the data entry of defects into a form based graphical user interface 220. With the appropriate indexing of the regions, these defects are annotated on a CAD Model 210. Further, with all the individual CAD models annotated, the overall part is visualized 230. In this manner, the software makes possible a roundtrip engineering of the defects where a form based data entry is mapped to a 3D visualization of the defect on a rendered CAD model of the part 50.

The present invention has been described in an illustrative manner. It is to be understood that the terminology, which has been used, is intended to be in the nature of words of description rather than of limitation.

Many modifications and variations of the present invention are possible in light of the above teachings. Therefore, the present invention may be practiced other than as specifically described.

What is claimed is:

1. A system for annotating defects in a part to be inspected comprising:
a plurality of defect annotations for the part where each of the defect annotations has a type and a severity; and
a Computer Aided Design (CAD) model of the part stored on a nonvolatile memory where the CAD model comprises of a plurality of geometrical features where each of the geometrical features is optionally associated with one or more of the plurality of defect annotations.

2. A system as set forth in claim 1 further comprising a plurality of images of the part; and
a Computer Aided Design (CAD) model of the part stored on a nonvolatile memory where the CAD model comprises of a plurality of geometrical features where each of the geometrical features is optionally associated with one or more of the plurality of defect annotations.

3. A system as set forth in claim 1 including a mobile device application used by a part inspection agent to retrieve an image to be inspected and the CAD model to be annotated.

4. A system as set forth in claim 3 including a server supporting the mobile device application.

5. A system as set forth in claim 4 including a desktop application supported by the server to display the inspection images and required view of the CAD model.

6. A system as set forth in claim 4 including an application tier supporting the server.

7. A system as set forth in claim 6 wherein the application tier comprises a business logic layer and a data access layer.

8. A system as set forth in claim 6 including a data tier supporting the application tier.

9. A system as set forth in claim 8 wherein the data tier comprises server stored procedures.

10. A system as set forth in claim 8 including a data access engine to retrieve appropriate information from the data tier.

11. A method of learning for a system for annotating defects in a part comprising the steps of:
analyzing engineering data, inspection defect data, repair data (times associated with particular defect types and specific part locations of the defect) for the part; and
displaying “optimum” engineering parameters for manufacturing the part.

12. A method as set forth in claim 11 including the step of collecting all manufacturing quality related data for the part.

13. A method as set forth in claim 12 wherein the manufacturing quality related data comprises chemical elements, mold pour data, and critical dimension data.

14. A method as set forth in claim 12 including the step of developing XRAY technique utilizing a CAD model and part.

15. A method as set forth in claim 14 including the step of digitally recording inspection results onto the CAD model.

16. A method as set forth in claim 15 including the step of creating CAD model with all associated defects annotated on the CAD model.

17. A method as set forth in claim 11 including the step of collecting all repair operation times associated with each defect by corresponding view.

18. A method as set forth in claim 11 including the step of pre-screen views to inspect prone defect areas of the part.

19. A method as set forth in claim 11 including the step of examining an image of the part and determining if there are any defects observable on the part.

20. A method as set forth in claim 19 including the step of annotating the CAD model at an appropriate position and with a type and severity of the observed defect.
